(19) United States
(12) Patent Application Publication
(10) Pub. No.: US 2008/0025256 A1
(43) Pub. Date: Jan. 31, 2008

(54) Multicasting techniques in wireless networks

(76) Inventors: Boris Ginzburg, Haifa (IL); Max Fudim, Kiriat Bialik (IL)

Correspondence Address: INTEL CORPORATION;c/o INTELLEVATE, LLC, P.O. BOX 52050, MINNEAPOLIS, MN, 55402, US

(21) Appl. No.: 11/494,390

(22) Filed: Jul. 26, 2006

(51) Int. Cl. H04Q 7/00; H04J 3/24; H04L 12/56

(52) U.S. Cl. 370/329; 370/412; 370/349

(57) ABSTRACT

An embodiment of the present invention provides an apparatus, comprising an access point (AP) capable of broadcasting to at least one mobile node in a wireless network, wherein the AP is further capable of utilizing differentiated broadcast policies for multicast transmissions within said wireless network.

### BACKGROUND

Wireless networks have grown increasingly in importance and have varying uses. One such use may include multicasting. Multicasting is the ability of a communication network to accept a single message from an application and to deliver copies of the message to multiple recipients at different locations. Although not limited in this respect, one such multicasting technique focuses on modifying frames buffering for downlink multicast traffic in an Institute for Electronics and Electrical Engineers (IEEE) 802.11 wireless local area network. The IEEE 802.11 specification defines the following behavior when any Mobile Node is connected to a basic service set (BSS) and is in power save mode:
1. An Access Point (AP) shall buffer all multicast frames and indicate this in a Delivery Traffic Information Message (DTIM) Information element in the DTIM beacon;
2. It delivers buffered traffic to all Mobile Nodes immediately following the next beacon frame containing a DTIM transmission.

Typically the DTIM Period is equal to two or three Beacon Intervals, which means that multicast frames will be buffered at an AP for relatively long periods: max=DTIM_Period×Beacon Interval (e.g. 3*100 mSec). As a result, real-time multicast will suffer significant jitter and delay and thus cannot support, among other things, live video-broadcast.

Thus, a strong need exists for novel multicasting techniques in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flow chart of regular transmit and receive flows of one embodiment of the present invention;

FIG. 2 illustrates how a Mobile Node may use a 2-way Multicast Frame Subscription handshake to activate AP mechanisms to improve multicast traffic reliability according to one embodiment of the present invention;

FIG. 3 shows a method of operation according to one embodiment of the present invention; and

FIG. 4 illustrates the system according to one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An embodiment of the present invention may extend the existing IEEE 802.11 specification by introducing differentiated mechanisms for multicast frames handling when some Mobile Nodes in a cell are in a power save mode. An embodiment of the present invention decreases overall latency of multicast traffic of a Wireless Fidelity (Wi-Fi) Cell while keeping overall power consumption of Mobile Nodes in the cell less then present mechanisms for multicast frames transmission. This may be achieved by differentiation of Mobile Nodes that are expecting to receive certain multicast traffic and those that are not.

In an embodiment of the present invention, differentiated policies for multicast traffic buffering and delivery may be based on type of multicast (hereinafter referred to as multicast frames buffering policy).

Although not limited in this respect, as an illustration of the present invention, two new buffering/delivery policies are provided:
1. Multicast frames—partial buffering (delayed transmit).
2. Multicast frames—no buffering (immediate transmit).

When Partial Buffering is selected, multicast frames may be transmitted by the Access Point subsequent to the transmission of the Beacon frame containing a new Information Element such as, but not limited to, MTIM (Multicast Traffic Indication Map) with an indication about buffered multicast traffic. MTIM may be broadcast by the Access Point in every Beacon frame like a regular Traffic Indication Map (TIM) for unicast traffic. One of the fields in that Information Element may be a Virtual Bitmap by means of which the Access Point notifies all Mobile Nodes in the cell about buffered frames per Multicast ID. Multicast ID may be a unique identifier for a L2 Multicast Address which may be assigned at a time when a first Mobile Node subscribes to that L2 Multicast Address. Note that in an embodiment of the present invention, case frames may be buffered at the Access Point maximum of one Beacon Interval.

When the “No Buffering” mode is selected, multicast frames may be transmitted immediately, without buffering at all despite the fact that there might be Mobile Nodes in the power saving (PS) Mode. In this case, the loss of frames is responsibility of the mobile node, since it was informed of pending multicast traffic sent though MTIM.

In an embodiment of the present invention, the policy for multicast buffering and delivery may be decided by the AP and may be based on frame type (for example through Differentiated Services Code Point (DSCP) marking). The mapping DSCP □ multicast policy may be setup by IT (both in AP and in broadcast applications)—similar to what is done now for unicast voice of Internet Protocol (VoIP) traffic.

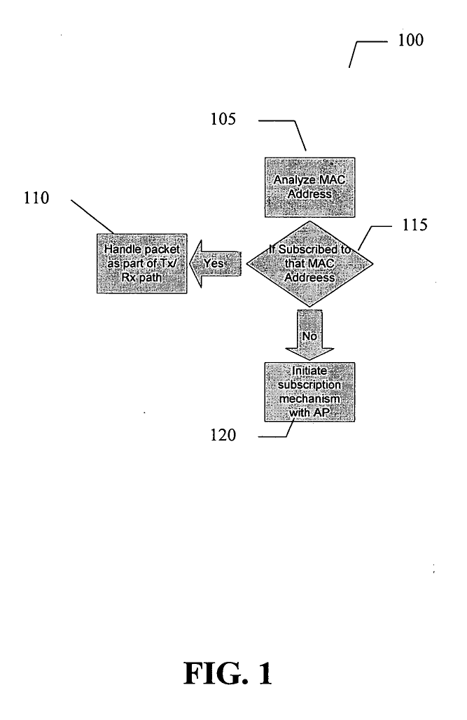

Turning now to the figures, FIG. 1, illustrates generally at 100, a flow chart of regular transmit and receive flows of one embodiment of the present invention wherein at 105 the Media Access Control (MAC) address is analyzed. At 115, if subscribed to that MAC address, then the packet is handled as part of the transmit and receive path at 110. If not subscribed, then at 120, a subscription with the AP is initiated.

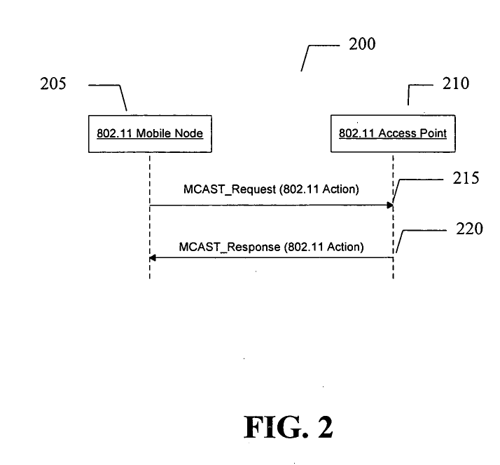

To become eligible to enjoy the more flexible multicast traffic buffering policy of an embodiment of the present invention, the Mobile Node may activate a subscription handshake. As seen in FIG. 2, shown generally as 200, a Mobile Node 205 may use a 2-way Multicast Frame Subscription handshake which may include an MCAST_Request 215 and MCAS_Response 220, to activate the AP 210 mechanisms to improve multicast traffic reliability. The steps of FIG. 2 may be integrated as part of regular Transmit and Receive flows of an 802.11 NIC.

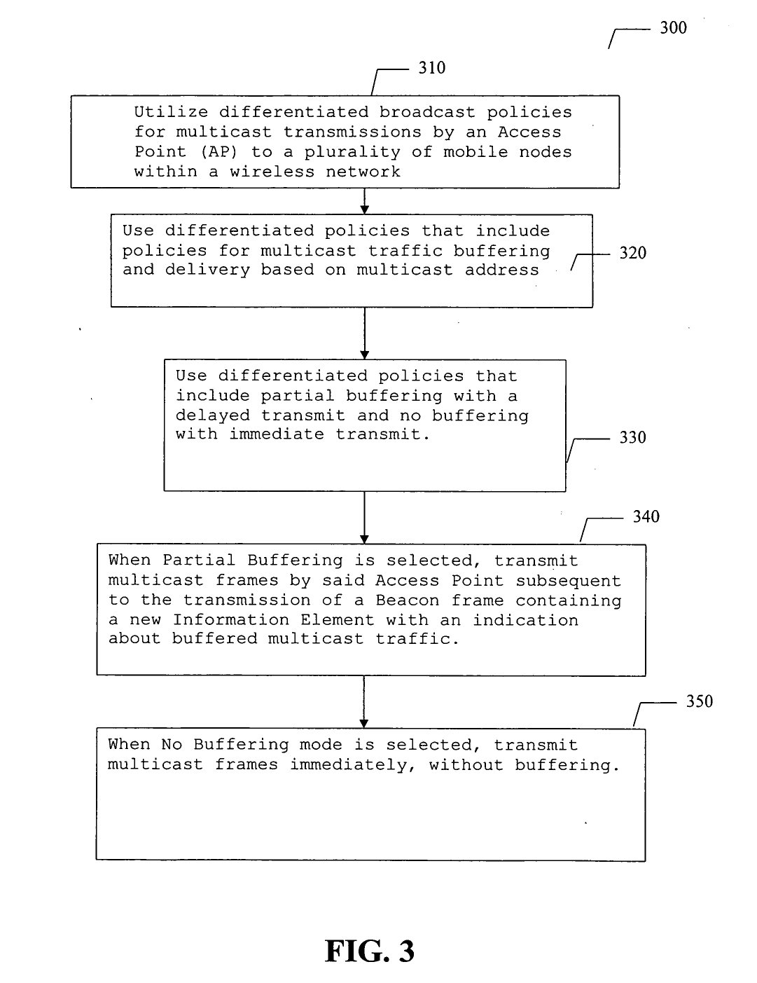

Turning now to FIG. 3, generally at 300, is a method of operation according to one embodiment of the present invention. The present method may comprise utilizing differentiated broadcast policies for multicast transmissions by an Access Point (AP) to a plurality of mobile nodes within a wireless network 210. An embodiment of the present method may further comprise using differentiated policies that include policies for multicast traffic buffering and delivery based on type of multicast 220. The differentiated policies may include partial buffering with a delayed transmit and no buffering with immediate transmit 230. Further, when Partial Buffering is selected 240, the AP may transmit multicast frames subsequent to the transmission of a Beacon frame containing a new Information Element with an indication about buffered multicast traffic; or when No Buffering mode is selected, the AP may transmit multicast frames immediately, without buffering. One of the fields in the Information Element may be a Virtual Bitmap, and by means of the AP, may notify all Mobile Nodes associated with the AP about buffered frames per a Multicast ID.

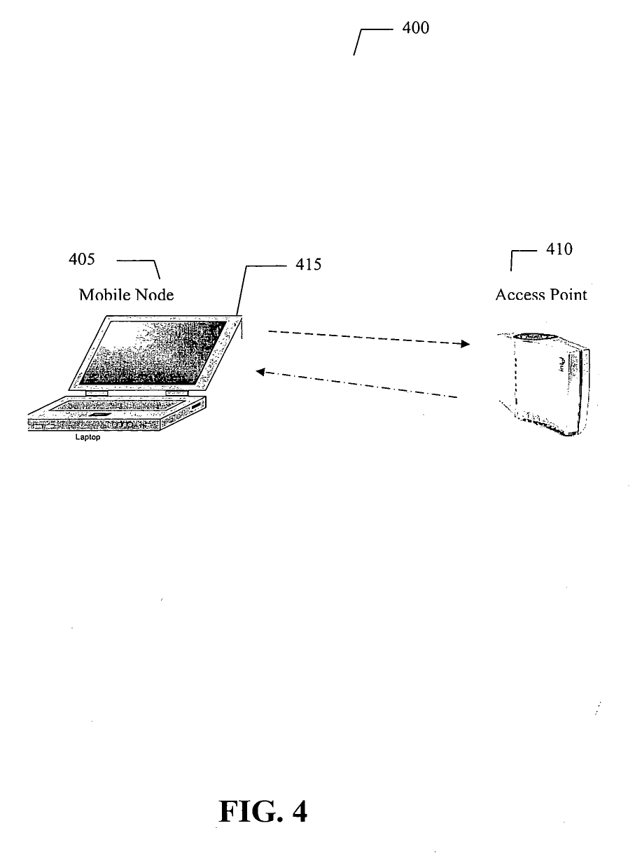

Turning now to FIG. 4, generally at 400 is a system according to an embodiment of the present invention, comprising at least one mobile node 405 operable in a wireless network, and an access point (AP) 410 capable of broadcasting to the at least one mobile node, wherein the AP is further capable of utilizing differentiated broadcast policies for multicast transmissions within the wireless network. The AP 410 may further comprises a dipole antenna 415 and the differentiated broadcast policies may be differentiated policies for multicast traffic buffering and delivery based on type of multicast. The differentiated policies may include partial buffering with a delayed transmit and no buffering with immediate transmit.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. An apparatus, comprising:
an access point (AP) capable of broadcasting to at least one mobile node in a wireless network, wherein said AP is further capable of utilizing differentiated broadcast policies for multicast transmissions within said wireless network.

2. The apparatus of claim 1, wherein said differentiated broadcast policies are differentiated policies for multicast traffic buffering and delivery based on type of multicast.

3. The apparatus of claim 2, wherein said differentiated policies include partial buffering with a delayed transmit and no buffering with immediate transmit.

4. The apparatus of claim 3, wherein when said Partial Buffering is selected, multicast frames are transmitted by said Access Point subsequent to the transmission of a Beacon frame containing a new Information Element with an indication about buffered multicast traffic.

5. The apparatus of claim 4, wherein one of the fields in said Information Element is a Virtual Bitmap, and by means of said AP notifies all Mobile Nodes associated with said AP about buffered frames per a Multicast ID.

6. The apparatus of claim 3, wherein when No Buffering mode is selected, multicast frames are transmitted immediately, without buffering.

7. The apparatus of claim 1, wherein said broadcast policies for multicast transmissions for multicast buffering and delivery is decided by said AP based on frame type.

8. A method, comprising:
utilizing differentiated broadcast policies for multicast transmissions by an Access Point (AP) to a plurality of mobile nodes within a wireless network.

9. The method of claim 8, further comprising using differentiated policies that include policies for multicast traffic buffering and delivery based on type of multicast.

10. The method of claim 9, further comprising using differentiated policies that include partial buffering with a delayed transmit and no buffering with immediate transmit.

11. The method of claim 10, further comprising transmitting multicast frames by said Access Point subsequent to the transmission of a Beacon frame containing a new Information Element with an indication about buffered multicast traffic when Partial Buffering is selected.

12. The method of claim 11, wherein one of the fields in said Information Element is a Virtual Bitmap, and by means of said AP, notifies all Mobile Nodes associated with said AP about buffered frames per a Multicast ID.

13. The method of claim 10, further comprising transmitting multicast frames immediately, without buffering when No Buffering mode is selected.

14. The method of claim 8, further comprising deciding said broadcast policies for multicast transmissions for multicast buffering and delivery by said AP based on frame type.

15. A machine-accessible medium that provides instructions, which when accessed, cause a machine to perform operations comprising:
utilizing differentiated broadcast policies for multicast transmissions by an Access Point (AP) to a plurality of mobile nodes within a wireless network.

16. The machine-accessible medium of claim 15, further comprising said instructions causing said machine to perform operations further comprising using differentiated policies that include policies for multicast traffic buffering and delivery based on type of multicast.

17. The machine-accessible medium of claim 16, further comprising said instructions causing said machine to perform operations further comprising using differentiated policies that include partial buffering with a delayed transmit and no buffering with immediate transmit.

18. The machine-accessible medium of claim 17, further comprising said instructions causing said machine to perform operations further comprising transmitting multicast frames by said Access Point subsequent to the transmission of a Beacon frame containing a new Information Element with an indication about buffered multicast traffic when Partial Buffering is selected.

19. The machine-accessible medium of claim 17, further comprising said instructions causing said machine to perform operations further comprising transmitting multicast frames immediately, without buffering when No Buffering mode is selected.

20. A system, comprising:
at least one mobile node operable in a wireless network; and
an access point (AP) capable of broadcasting to said at least one mobile node, wherein said AP is further capable of utilizing differentiated broadcast policies for multicast transmissions within said wireless network.

21. The system of claim 20, wherein said AP further comprises a dipole antenna.

22. The system of claim 20, wherein said differentiated broadcast policies are differentiated policies for multicast traffic buffering and delivery based on type of multicast.

23. The system of claim 22, wherein said differentiated policies include partial buffering with a delayed transmit and no buffering with immediate transmit.

24. The system of claim 23, wherein when said Partial Buffering is selected, multicast frames are transmitted by said Access Point subsequent to the transmission of a Beacon frame containing a new Information Element with an indication about buffered multicast traffic.

25. The system of claim 20, wherein said broadcast policies for multicast transmissions for multicast buffering and delivery is decided by said AP based on frame type.
